(19) United States
(12) Patent Application Publication
(10) Pub. No.: US 2005/0225437 A1
(43) Pub. Date: Oct. 13, 2005

(54) Information processing apparatus for receiving predetermined information, and program product and method therefor

(75) Inventors: Shinichi Shiotsu, Kawasaki (JP); Teruhisa Ninomiya, Kawasaki (JP); Isamu Yamada, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 10/921,262

(22) Filed: Aug. 19, 2004

(30) Foreign Application Priority Data
Apr. 13, 2004 (JP) 2004-117579

(51) Int. Cl. H04Q 5/22

(52) U.S. Cl. 340/10.51; 340/10.34

(57) ABSTRACT

An information processing apparatus communicates with a separate passive device, to receive specific information from the separate device. The information processing apparatus includes an antenna, a transmitter and a receiver both coupled to the antenna, and a control unit for controlling the transmitter. The control unit causes the transmitter to transmit a signal at a low transmission power and waits for reception by the receiver of a response signal from the separate device. When the specific information is detected in the response signal, the control unit causes the transmitter to transmit a signal at a high transmission power by raising the transmission power of the transmitter, to thereby enable information to be read from or written to the separate device.

### FIELD OF THE INVENTION

The present invention relates generally to contactless read from and write to an information storage medium such as a contactless IC card and an RF ID tag, and more particularly to a contactless reader and writer device that can be incorporated in battery-powered mobile apparatus.

### BACKGROUND ART

Contactless or noncontact IC cards or smartcards and RF ID tags are becoming pervasive recently. A contactless IC card is applicable to the Japanese Resident Register ID card in compliance with the ISO 14443 standard, the electronic ticketing card, employee card and electronic money which are in compliance with the FeliCa™ standard, and the like. The RF ID tag is applicable to a merchandise management system, an inventory management system and a physical distribution system which are in compliance with the ISO 15693 standard, and other systems. Today, dedicated contactless reader/writer devices are used to read from and write to the respective contactless IC card and RF ID tag.

Information storage media, such as so-called passive contactless IC cards and RF ID tags, do not include batteries, and hence need to receive power from a contactless reader/writer device through electromagnetic induction. Thus the reader/writer device is required to flow a relatively large current. Consequently, when the reader/writer device is used, for example, as a sensor at a gate or for login to a notebook personal computer or a mobile terminal, it must be permanently activated, because it is not known what kind of contactless IC card or RF ID tag is brought in its proximity and when it is brought in its proximity. This causes the reader/writer device to dissipate a large amount of power, and considerably shortens the battery run time.

The PCT international publication, WO 00/65551, published on Nov. 2, 2000, discloses supplying power for reading an RF ID only when action is detected by an infrared sensor.

Sasuga et al. in the Japanese Unexamined Patent Publication JP HEI 11-126240 (A) published on May 11, 1999 discloses a reader/writer controller which, while in a standby state, transmits command data by intermittently turning on the power for a transmission section.

### SUMMARY OF THE INVENTION

In an aspect of the invention, an information processing apparatus communicates with a separate passive device having no active power supply, to receive specific information from the separate device. The information processing apparatus includes an antenna, a transmitter and a receiver both coupled to the antenna, and a control unit for controlling the transmitter. The control unit causes the transmitter to transmit a signal at a low transmission power and waits for reception by the receiver of a response signal from the separate device. When the specific information is detected in the response signal, the control unit causes the transmitter to transmit a signal at a high transmission power by raising the transmission power of the transmitter, to thereby enable information to be read from or written to the separate device.

The invention also relates to a program for implementing the information processing apparatus above. The invention also relates to a method for implementing the information processing apparatus above.

### BRIEF DESCRIPTION OF THE DRAWINGS

FIG. 1 illustrates an information processing apparatus which includes a contactless reader or a contactless reader and writer device that reads and writes information from and to contactless IC cards and RF ID tags in compliance with respective different standards for information storage media, in accordance with an embodiment of the present invention;

FIG. 2 illustrates an internal configuration of each of the contactless IC cards and the RF ID tags;

FIGS. 3A and 3B show state transition diagrams in a detection mode of operation for detecting a contactless IC card in accordance with one of the standards for the reader/writer, and in another detection mode of operation for detecting an RF ID tag in accordance with another standard, respectively, in accordance with the embodiment of the invention;

FIG. 4 illustrates the transmission intervals or polling cycles and the magnitudes of transmission output powers or amplitudes in the states of the reader/writer;

FIGS. 5A and 5B illustrate alternate and cyclic changes of the detection modes of operation of the reader/writer, respectively;

FIGS. 6A, 6B and 6C show timing charts for the polling cycle and the data transmission and reception developed by the reader/writer in the respective states;

FIG. 7 shows a flowchart for adjusting the polling cycle and the transmission power, executed by the reader/writer in a plurality of alternate or cyclic detection modes of operation;

FIG. 8 shows a timing chart of the states and the transmission power developed by the reader/writer in accordance with the flowchart of FIG. 7 in the two alternate modes of operation M0 and M1;

FIG. 9 illustrates another exemplary timing chart of the states and the transmission power developed by the reader/writer in accordance with the flowchart of FIG. 7 in the two alternate modes of operation M0 and M1;

FIGS. 10 and 11 illustrate a further exemplary timing chart of the states and the transmission power developed by the reader/writer in accordance with the flowchart of FIG. 7 in the three different cyclic modes of operation M0, M1 and M2;

FIG. 12 shows another state transition diagram for detecting the contactless IC card in the contactless IC card detection mode of operation first and then entering the RF ID tag detection mode of operation to detect the RF ID tag, in accordance with another embodiment of the invention;

FIGS. 13A and 13B show a flowchart for detecting the contactless IC card in the contactless IC card detection mode of operation and then entering the RF ID tag detection mode of operation to detect the RF ID tag, in accordance with the state transition diagram of FIG. 12, performed by the processor and by the reader/writer, in accordance with the embodiment of the invention;

FIG. 14A, 14B and 14C illustrate screens displayed on the display device in the flowchart of FIGS. 13A and 13B; and

FIG. 15 illustrates an exemplary timing chart of the states and the transmission power developed by the reader/writer in accordance with the flowchart of FIGS. 13A and 13B in the two modes of operation, M0 and M1.

### DESCRIPTION OF THE PREFERRED EMBODIMENTS

Extra circuitry is required to incorporate an infrared sensor in a reader/writer, resulting in increased size, weight and cost. Meanwhile, an infrared sensor may erroneously detect an irrelevant object other than a contactless IC card and an RF ID tag.

To turn on the transmission unit of the reader/writer intermittently, turn-on intervals must be made relatively short to prevent detection failures. Thus no significant power-saving effects can be expected thereof.

The inventors have recognized that power consumption must be considerably reduced to incorporate a reader/writer for the contactless IC card and the RF ID tag in a battery-powered apparatus.

It is an object of the present invention to reduce power consumption of the reader/writer for information storage medium.

It is another object of the invention to provide a reader/writer capable of operating at low power consumption and in compliance with a plurality of standards.

In accordance with the invention, power consumption of the reader/writer for information storage medium can be reduced.

The invention will be described with reference to the accompanying drawings. Throughout the drawings, similar symbols and numerals indicate similar items and functions.

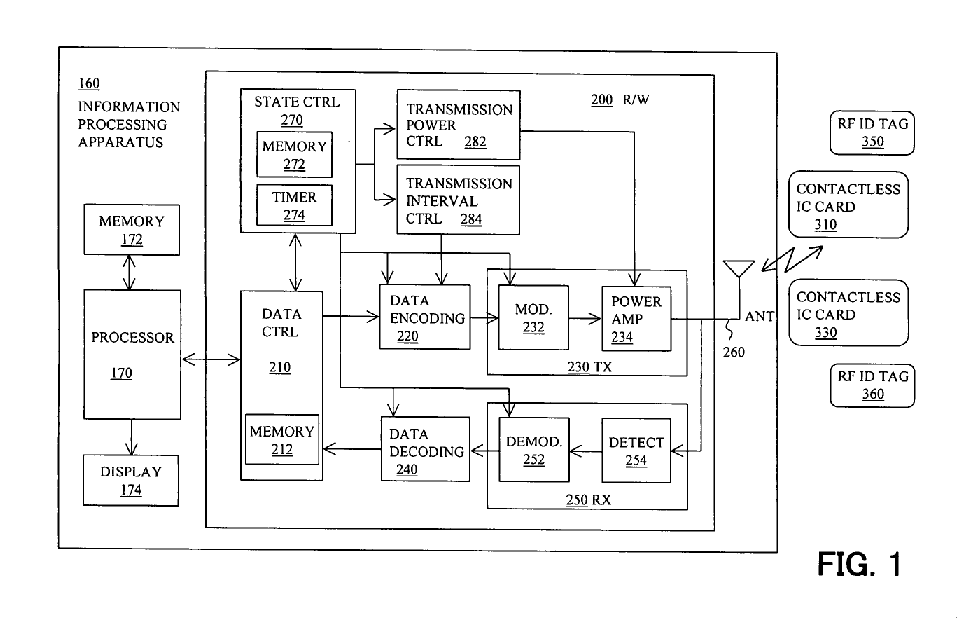

FIG. 1 illustrates an information processing apparatus 160 which includes a contactless reader or contactless reader and writer device (R/W) 200 (referred to simply as a reader/writer hereinafter) which reads and writes information from and to contactless IC cards 310 and 330 and RF ID tags 350 and 360 in compliance with respective different standards for information storage media, in accordance with an embodiment of the present invention. The information processing apparatus 160 further includes a processor 170 for communicating data and control signals with the reader/writer 200, a memory 172 for storing programs and data, and a display device 174. The information processing apparatus 160 may be a mobile telephone, a PDA (Personal Digital Assistant) or the like, equipped with a separate antenna (not shown) for remote RF electromagnetic wave signal communications, such as mobile telephone communication and wireless LAN communication. The reader/writer 200 is capable of operating, in a time-division multiplex manner, i.e. alternately or cyclically, in contactless IC card detection modes of operation for detecting the respective contactless IC cards 310 and 330 in different standards, and in RF ID tag detection modes of operation for detecting the respective RF ID tags 350 and 360 in different standards. In this embodiment, the contactless IC cards 310 and 330 and the RF ID tags 350 and 360 are of the passive type having no active or persistent power supply.

The reader/writer 200 is provided with a data control unit 210 including a memory 212, a data encoding unit 220 for transmission, a transmitter unit (TX) 230, a data decoding unit 240, a receiver unit (RX) 250, a state control unit 270 including a memory 272 and a timer 274, and a transmission power control unit 282 and a transmission interval or polling cycle control unit 284, both of which are coupled to the state control unit 270. The transmitter unit 230 includes a modulation unit 232 for transmission and a transmission power amplifier unit 234 coupled to a coil antenna (ANT) 260. The receiver unit 250 includes a detection unit 254 for reception coupled to the coil antenna 260, and a demodulation unit 252. The data encoding unit 220 is capable of operating in a plurality of encoding schemes in compliance with a plurality of respective standards. The data decoding unit 240 is capable of operating in a plurality of decoding schemes corresponding to the plurality of encoding schemes. The data modulation unit 232 is capable of operating in a plurality of modulation schemes in compliance with a plurality of respective standards. The data demodulation unit 252 is capable of operating in a plurality of respective demodulation schemes corresponding to the plurality of modulation schemes.

The ISO/ICE 1443-2 standard defines schemes of types A and B for contactless IC cards. The scheme of type A defines ASK as a modulation scheme and Modified Mirror encoding as an encoding scheme for communication from a reader to a contactless IC card, and defines load modulation as a modulation scheme and Manchester encoding as an encoding scheme for communication from the contactless IC card to the reader. The scheme of type B defines ASK as modulation scheme and NRZ-L encoding as an encoding scheme for communication from a reader to a contactless IC card, and defines load modulation as modulation scheme and NRZ-L (BPSK) encoding as an encoding scheme for communication from the contactless IC card to the reader. The scheme of type C, which is the proposed ISO standard for use in electronic money and the like in Japan, defines ASK as a modulation scheme and Manchester encoding as an encoding scheme for communication from a reader to a contactless IC card, and defines load modulation as a modulation scheme and Manchester encoding as an encoding scheme for communication from the contactless IC card to the reader.

The ISO/IEC 15693 standard and the Magellan scheme define respective different RF ID tag schemes. The ISO/IEC 15693 standard defines ASK as a modulation scheme and PWM as an encoding scheme for communication from a reader to an RF ID tag, and defines a load modulation scheme (OOK and FSK) as a modulation scheme and Manchester encoding as an encoding scheme for communication from the RF ID tag to the reader. The Magellan scheme defines PJM (Phase Jitter Modulation) as a modulation scheme and DFMFM (Double Frequency Modified Frequency Modulation) as an encoding scheme for communication from a reader to an RF ID tag, and defines the load modulation scheme (BPSK) as a modulation scheme and MFM encoding as an encoding scheme for communication from the RF ID tag to the reader.

In FIG. 1, the processor 170 sends and receives control signals and data to and from the data control unit 210 of the reader/writer 200. The data control unit 210 supplies the data encoding unit 220 with data to be transmitted which is provided from the processor 170. The data encoding unit 220 encodes the data in a predetermined encoding scheme selected by the state control unit 270, and provides the encoded data to the modulation unit 232 of the transmitter unit 230. The modulation unit 232 modulates a carrier with the encoded data in a predetermined modulation scheme, and provides the modulated carrier signal to the amplifier unit 234. The transmission power amplifier unit 234 amplifies the modulated carrier signal and transmits the signal via the antenna 260 at a selected, predetermined transmission power.

The state control unit 270 determines the current detection mode of operation of the reader/writer 200, and supplies the transmission power control unit 282 and the transmission interval control unit 284 with a switching control signal corresponding to the current control state of the reader/writer 200. In accordance with the current detection mode of operation, the state control unit 270 supplies the data encoding unit 220 and the data decoding unit 240 with control signals for selecting encoding and decoding schemes respectively, and supplies the modulation unit 232 and the demodulation unit 252 with control signals for selecting modulation and demodulation schemes respectively. The interval control unit 284 enables or disables the data encoding unit 220 in accordance with the current control state. The transmission power control unit 282 controls the transmission power of the transmission power amplifier unit 234 in accordance with the current control state.

In response to the contactless IC cards 310 and 330, the reader/writer 200 is typically capable of operating normally at a higher or medium level transmission power (e.g., 50 mW) within a distance range of approximately 1 cm. In response to the RF ID tags 350 and 360, the reader/writer 200 is typically capable of operating normally at a higher or highest level transmission power (e.g., 100 mW or 50 mW) within a range of a few centimeters to a few meters. At a low transmission power, such as approximately one half the transmission power that enables the normal operation within the predetermined range (e.g., 25 mW), the reader/writer 200 does not operate normally in response to the contactless IC cards 310 and 330 and the RF ID tags 350 and 360, but is capable of receiving a unique ID, which is a unique identification information, from them.

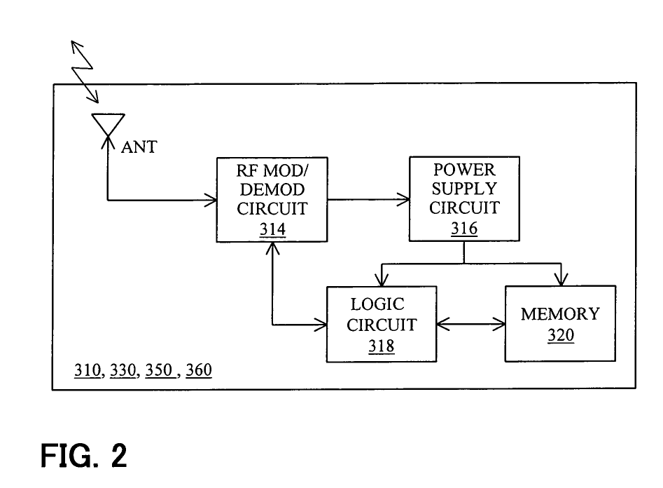

FIG. 2 illustrates an internal configuration of each of the contactless IC cards 310 and 330 and the RF ID tags 350 and 360. Each of the contactless IC cards 310 and 330 and the RF ID tags 350 and 360 includes a coil antenna ANT, an RF modulation and demodulation circuit 314, a passive power supply circuit 316, a logic circuit 318 and a memory 320.

Each of the contactless IC cards 310 and 330 and the RF ID tags 350 and 360 stores electric charge generated through induced current, received by the RF modulation and demodulation circuit 314 from the reader/writer 200, in a capacitor (not shown) inside the power supply circuit 316, operates on power supplied by the power supply circuit 316, and sends and receives information to and from the reader/writer 200 through at least one predetermined modulation scheme via the RF modulation/demodulation circuit 314. The logic circuit 318 reads and writes information from and to the memory 320 in accordance with commands from the reader/writer 200.

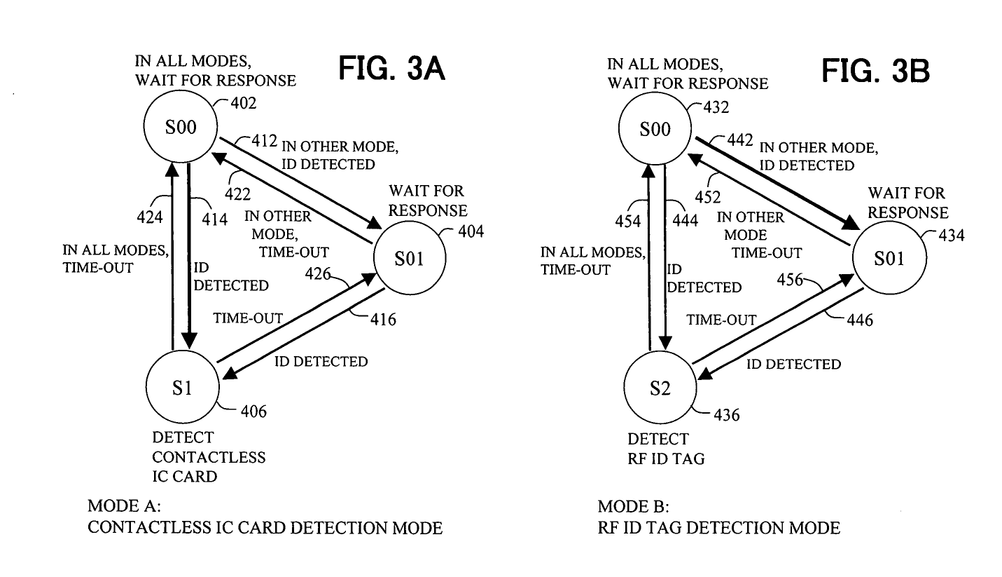

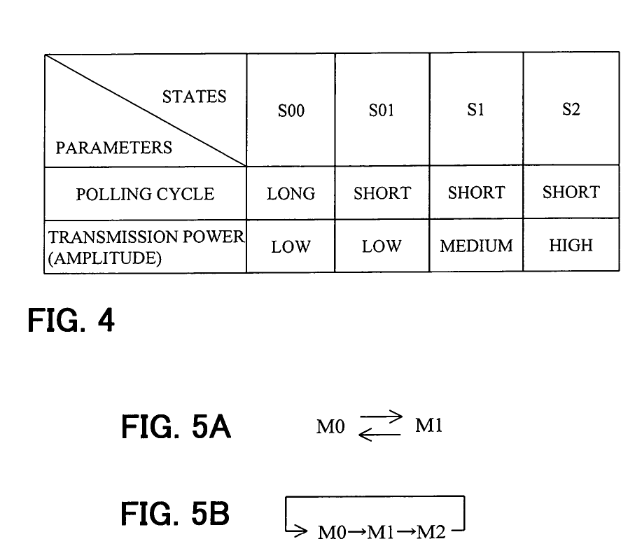

FIGS. 3A and 3B show state transition diagrams in a detection mode of operation MODE A for detecting a contactless IC card in compliance with one of the standards for the reader/writer 200, and in another detection mode of operation MODE B for detecting an RF ID tag in compliance with another one of the standards, respectively, in accordance with the embodiment of the invention. FIG. 4 illustrates the transmission intervals or polling cycles and the magnitudes of transmission output powers or amplitudes in the states of the reader/writer 200. The two detection modes of operation MODES A and B in accordance with the two standards are described here. However, additional detection modes of operation for a contactless IC card and/or an RF ID tag in compliance with other standards may be used.

Referring to FIGS. 3A and 3B, the reader/writer 200 assumes a state S00 designated as reference numerals 402 and 432 in its initial state in each of the contactless IC card detection mode of operation MODE A and the RF ID tag detection mode of operation MODE B. The state S00 indicates that responses from the contactless IC cards 310 and 330 and the RF ID tags 350 and 360 have not been previously detected in any of the detection modes of operation. In the state S00 in each of the two detection modes of operation, the reader/writer 200 sets a longest transmission interval or polling cycle PL (e.g., polling cycle of 500 ms) and a low or lowest transmission power LL (e.g., 25 mW), and waits for reception of a response from the contactless IC card 310 or the RF ID tag 350.

In FIG. 3A, the reader/writer 200 goes into a state S01 designated as 404 as indicated by an arrow 412 in the current contactless IC card detection mode of operation MODE A, when reception of a response is detected previously in the other mode of operation (e.g., MODE B) while the reader/writer 200 is in the state S00 designated as 402. In the state S01, the reader/writer 200 sets a short polling cycle PS (e.g., 200 ms) and the low transmission power LL (e.g., 25 mW) for the contactless IC card detection mode of operation MODE A. The reader/writer 200 returns to the state S00 as indicated by an arrow 422 due to a time-out, when no reception of a response is detected for a predetermined period of time in any of the detection modes of operation while the reader/writer 200 is in the state S01.

The reader/writer 200 goes into a state S1 designated as 406 as indicated by an arrow 414, when reception of a response is detected from the contactless IC card 310 in the current contactless IC card detection mode of operation MODE A while the reader/writer 200 is in the state S00. In the state S1, the reader/writer 200 sets the short polling cycle PS (e.g., 200 ms) and a medium-level transmission power ML (e.g., 50 mW). The reader/writer 200 returns to the state S00 as indicated by an arrow 424 due to a time-out, when no reception of a response is detected for a predetermined period of time in any of the detection modes of operation while the reader/writer 200 is in the state S1.

The reader/writer 200 goes into the state S1 designated as 406 as indicated by an arrow 416, when reception of a response is detected from the contactless IC card 310 in the current contactless IC card detection mode of operation MODE A while the reader/writer 200 is in the state S01. In the state S1, the reader/writer 200 sets the short polling cycle PS (e.g., 200 ms) and the medium-level transmission power ML (e.g., 50 mW). The reader/writer 200 goes into the state S01 as indicated by an arrow 426, when a time-out occurs while it is in the state S1, because no reception of a response is detected for a predetermined period of time in the current contactless IC card detection mode of operation MODE A and when reception of a response is detected or no time-out occurs in all other detection modes of operation.

In FIG. 3B, the reader/writer 200 goes into the state S01 designated as 434 as indicated by an arrow 442 in the current RF ID tag detection mode of operation MODE B, when reception of a response is previously detected in other mode (e.g., MODE A) while the reader/writer 200 is in the state S00 designated as 432. In the state S01, the reader/writer 200 sets the short polling cycle PS (e.g., 200 ms) and the low transmission power LL (e.g., 25 mW) for the RF ID tag detection mode of operation MODE B. The reader/writer 200 returns to the state S00 as indicated by an arrow 452 due to a time-out, when no reception of a response is detected for a predetermined period of time in any of the detection modes of operation while the reader/writer 200 is in the state S01.

The reader/writer 200 goes into a state S2 designated as 436 as indicated by an arrow 444, when reception of a response is detected from the RF ID tag 350 in the current RF ID tag detection mode of operation MODE B while the reader/writer 200 is in the state S00. In the state S2, the reader/writer 200 sets the short polling cycle PS (e.g., 200 ms) and a high or highest transmission power HL (e.g., 100 mW). The reader/writer 200 returns to the state S00 as indicated by an arrow 454 due to a time-out, when no reception of a response is detected for a predetermined period of time in any of the detection modes of operation while the reader/writer 200 is in the state S2.

The reader/writer 200 goes into the state S2 designated as 436 as indicated by an arrow 446, when reception of a response is detected from the RF ID tag 350 in the current RF ID tag detection mode of operation MODE B while the reader/writer 200 is in the state S01. In the state S2, the reader/writer 200 sets the short polling cycle PS (e.g., 200 ms) and the high or highest transmission power HL (e.g., 100 mW). The reader/writer 200 goes into the state S01 as indicated by an arrow 456, when a time-out occurs while it is in the state S2, because no reception of a response is detected for a predetermined period of time in the current RF ID tag detection mode of operation MODE B and when reception of a response is detected or no time-out occurs in all other detection modes of operation.

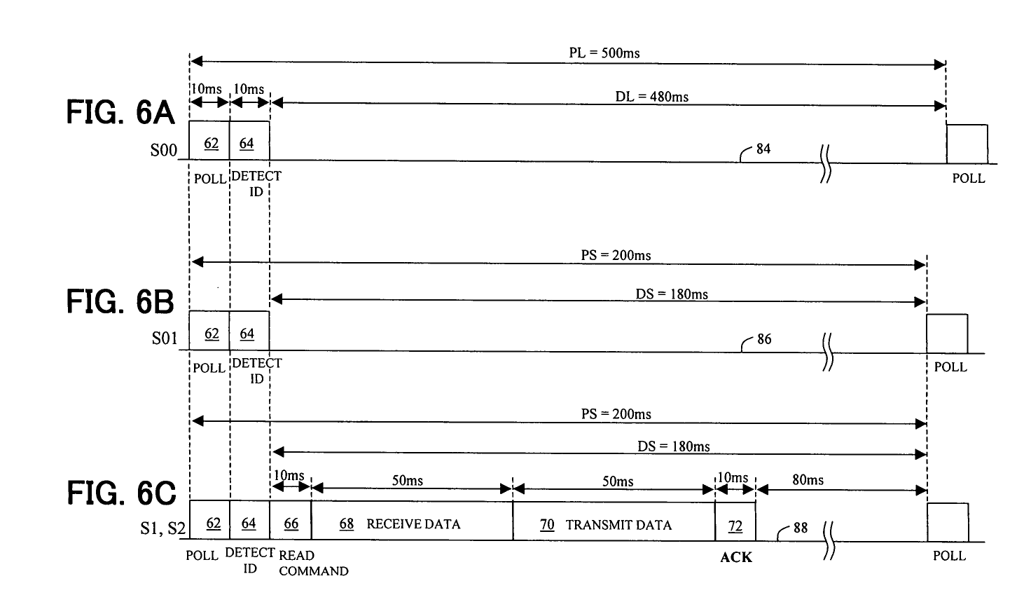

FIGS. 5A and 5B illustrate alternate and cyclic changes of the detection modes of operation of the reader/writer 200, respectively. The reader/writer 200 may alternate between two detection modes of operation M0 and M1, for example, the contactless IC card detection mode of operation MODE A and the RF ID tag detection mode of operation MODE B, as shown in FIG. 5A. Alternatively, the reader/writer 200 may cycle sequentially through three or more detection modes of operation M0, M1 and M2, for example, the detection mode of operation MODE A and a detection mode of operation MODE A′ of the two contactless IC cards 310 and 330 in the respective different standards, and the detection mode of operation MODE B of the RF ID tag 350 in a further standard, as shown in FIG. 5B. The detection modes of operation M0, M1 and M2 may be different ones of the contactless IC card and RF ID tag detection modes of operation in a plurality of different standards.

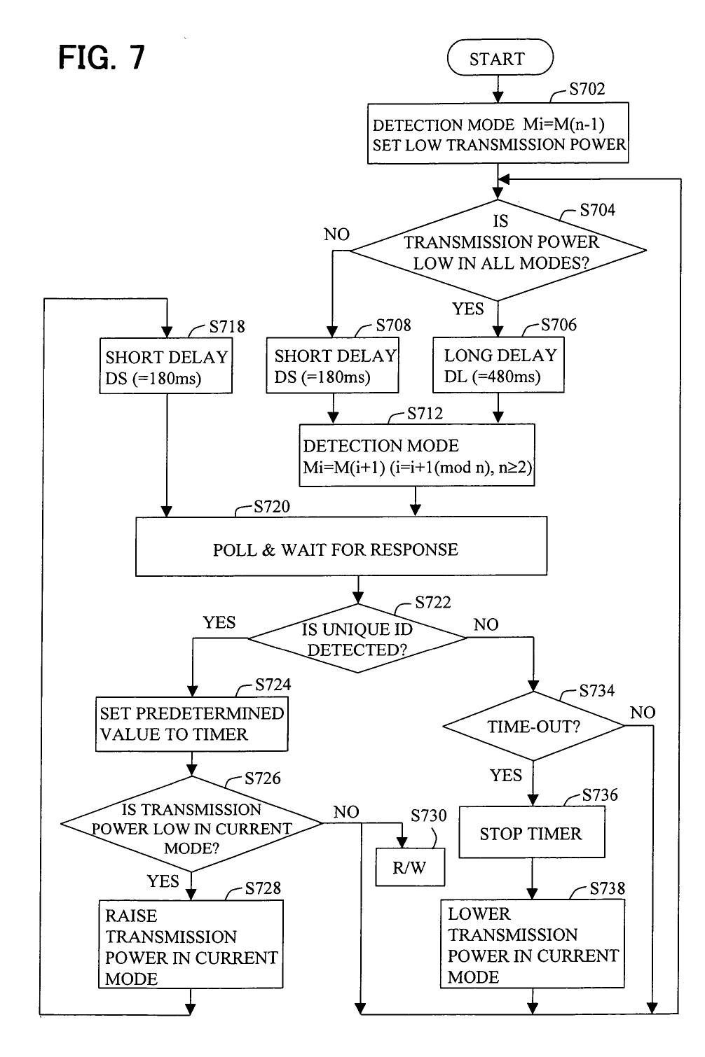

FIGS. 6A, 6B and 6C show timing charts for the polling cycle and the data transmission and reception developed by the reader/writer 200 in the states S00, S01, and S1 and S2, respectively.

In FIG. 6A, in the state S00, a polling signal is transmitted in a first time slot 62 having duration of, for example, 10 ms, in the long polling cycle PL of, for example, 500 ms, and an unmodulated signal is transmitted in a next short time slot 64 of, for example, 10 ms, to detect whether a response signal containing a unique ID is received. Then, the transmission is interrupted during the subsequent period of a long delay time DL 84 of, for example, 480 ms.

In FIG. 6B, in the state S01, a polling signal is transmitted in the first time slot 62 in the short polling cycle PS of, for example, 200 ms, and an unmodulated signal is transmitted in the next short time slot 64 to detect whether a response signal containing a unique ID is received. Then, the transmission is interrupted during the subsequent period of a short delay time DS 86 of, for example, 180 ms.

In FIG. 6C, in the states S1 and S2, a polling signal is transmitted in the first time slot 62 in the polling cycle PS of, for example, 200 ms, and an unmodulated signal is transmitted in the next short time slot 64 to detect reception of a response signal containing a unique ID. If necessary, a read command is transmitted in a next time slot 66 of, for example, 10 ms, and data is received in a next time slot 68 of, for example, 50 ms. In a next time slot 70 of, for example, 50 ms, a write command and data are transmitted, and ACK is received in a next time slot 72 of, for example, 10 Ms. Then, transmission is interrupted in a subsequent period of a short delay time DS 88 of, for example, 80 ms. The total delay time DS (66, 68, 70, 72 and 88) between the reception time slot 64 in the polling cycle and the transmission time slot 62 in the next polling cycle is equal in length to the short delay time DS 86 in FIG. 6B.

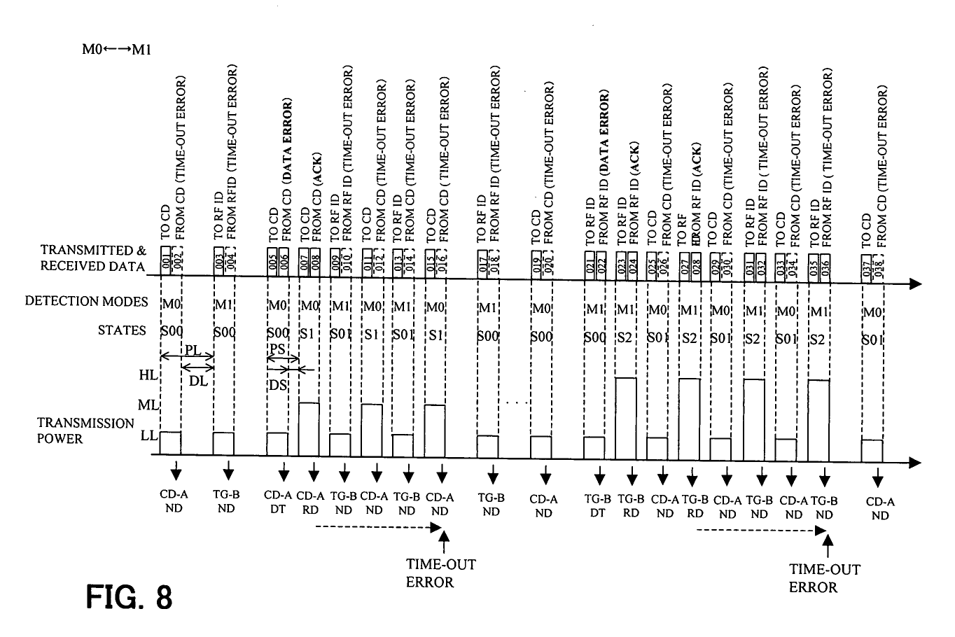

FIG. 7 shows a flowchart for adjusting the polling cycle and the transmission power, executed by the state control unit 270 of the reader/writer 200 in accordance with a control program stored in the memory 272 in a plurality, n, of alternate or cyclic detection modes of operation Mi's, where n represents an integer not less than 2 (n≧2), and i represents an integer which satisfies 0≦i≦n−1. The different detection modes of operation are used for detecting passive information storage media, in the time-division multiplex manner, in a plurality of corresponding different read/write schemes, such as types A and B of the ISO/IEC 1443-2 standard and the proposed type C for contactless IC cards, and the ISO/IEC 15693 standard and the Magellan scheme for RF ID tags. For example, the first detection mode of operation M0 may be used for detecting the contactless IC card 310 in compliance with type A of the ISO/IEC 1443-2 standard, and the second detection mode of operation M1 may be used for detecting the RF ID tag 350 in compliance with the ISO/IEC 15693 standard. For example, the third detection mode of operation M2 may be used for detecting the contactless IC card 330 in compliance with type B of the ISO/IEC 1443-2 standard.

At Step 702, the state control unit 270 sets an initial value M(n−1) as the detection mode of operation Mi (i=n−1), and controls the transmission power control unit 282 to set the transmission power of the amplifier unit 234 to the low level LL. At Step 704, the state control unit 270 determines whether the current transmission power is set to the low level LL in all of the number, n, of detection modes of operation M0 to M(n−1). If it is determined that the transmission power is set to the low level, the state control unit 270 at Step 706 controls the interval control unit 284 to provide the long time delay DL (e.g., 480 ms) before the next polling. If it is determined that the transmission power is not set to the low level, the state control unit 270 at Step 708 controls the interval control unit 284 to provide the short time delay DS (e.g., 180 ms) before the next polling. At Step 712, the state control unit 270 goes into the next detection mode of operation Mi=M(i+1) (i=i+1 (mod n)). At first, it goes into the detection mode of operation M0. The state control unit 270 controls the data encoding unit 220 and the modulation unit 232 to operate in the respective predetermined encoding and modulation schemes, in accordance with the standard of the current mode of operation Mi.

At Step 720, the data control unit 210 transmits and receives data in the detection mode of operation Mi set by the state control unit 270 to thereby allow the reader/writer 200 to poll the contactless IC card 310 or the RF ID tag 350 and detect its response. The reader/writer 200 transmits data at the low transmission power LL at first. The response contains a unique ID of the contactless IC card 310 or the RF ID tag 350. In response to the polling, the contactless IC card 310 or the RF ID tag 350 transmits back a response signal, modulated with the unique ID data using the energy stored in a capacitor charged by electromagnetic energy received from the transmitter unit 230. When the electromagnetic energy is sufficiently large, the contactless IC card 310 or the RF ID tag 350 can transmit data stored in the memory 320 in accordance with the read command from the reader/writer 200 after the transmission of the unique ID, and can also write received data into the memory 320 in accordance with the write command. When the contactless IC card 310 or the RF ID tag 350 receives the small electromagnetic energy that corresponds to the low transmission power LL, it can transmit only a response signal containing the unique ID at a low power.

At Step 722, the state control unit 270 determines whether a unique ID, corresponding to the detection mode of operation Mi, is detected in the response signal. If it is determined that the unique ID is detected, the control unit 270 at Step 724 sets a predetermined value to a timer 724 for time-out error detection, such as a down-counter, or overwrites the current count with the predetermined value. At Step 726, it is determined whether the transmission power is at the low level LL in the current detection mode of operation Mi, i.e., whether the current state is the state S00 or S01 in the state transition diagram of FIG. 3A or 3B. The transmission level in the detection mode of operation Mi is the low level LL at first. If it is determined that the transmission power is at the low level LL, the state control unit 270 causes the transmission power control unit 282 to raise the next transmission power (HL or ML). Thus the state control unit 270 causes the transmission power control unit 282 to raise the transmission power to the medium level ML in the state S1, if the current detection mode of operation Mi is the contactless IC card detection mode of operation MODE A in FIG. 3A. On the other hand, the state control unit 270 causes the transmission power control unit 282 to raise the transmission power to the high or highest level HL in the state S2, if the current detection mode of operation Mi is the RF ID tag detection mode of operation MODE B in FIG. 3B. Then, the procedure advances to Step 718. At Step 718, the state control unit 270 controls the interval control unit 284 to provide the short time delay DS before the next polling. At Step 720, the reader/writer 200 polls in the same detection mode of operation at the raised transmission power (HL or ML) to detect reception of a response. Thus, if a unique ID is detected while the transmission power is at the low level (LL), the transmission power is raised (to HL or ML) so as to perform the polling and the detection of reception of a response again.

At Step 726, if it is determined that the transmission power is not at the low level (LL), the procedure returns to Step 704. At the same time, if the data control unit 210 holds therein a control indication indicating data to be read and/or written, the state control unit 270 at Step 730 enables the data encoding unit 220, the transmitter unit 230, the data decoding unit 240 and the receiver unit 250, to transmit the read command and receive data and/or transmit the write command and data. The read and/or write is performed during the short time delay DS (FIG. 6C) at Step 708. Thus, if the transmission power is not at the low level, i.e., it is at the medium or high level (ML or HL), then corresponding data can be read from and/or written into the contactless IC card 310 or the RF ID tag 350, as occasion demands.

At Step 722, if the data control unit 210 does not detect the unique ID, the state control unit 270 at Step 734 determines whether the previously set timer 274 indicates a time-out. If it is determined that the timer does not indicate a time-out, the procedure returns to Step 704. If it is determined that the timer 274 indicates a time-out, the state control unit 270 stops the timer 274 at Step 736. At Step 738, the state control unit 270 causes the transmission power control unit 282 to set the next transmission power in the current detection mode of operation Mi to the low level LL. Then, the procedure returns to Step 704.

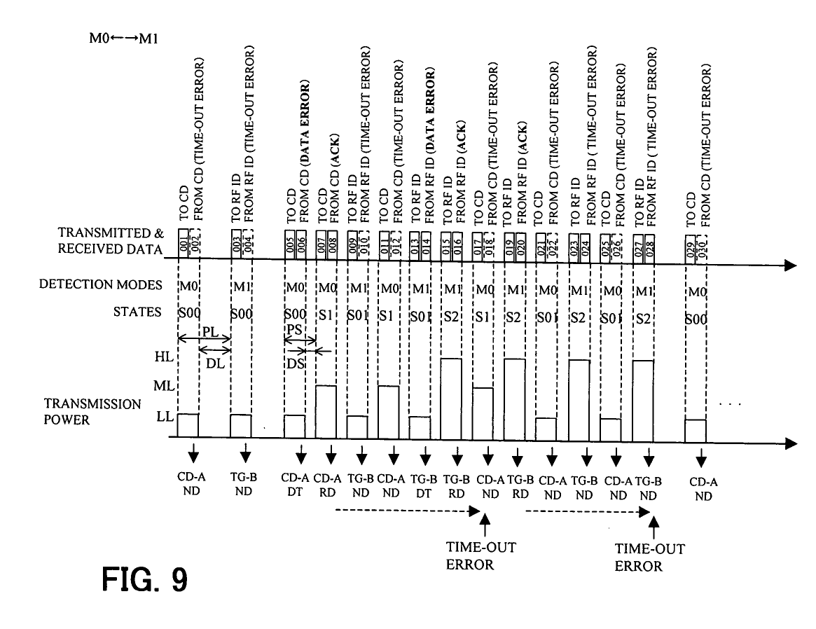

FIG. 8 shows a timing chart of the states and the transmission power developed by the reader/writer in accordance with the flowchart of FIG. 7 in the two alternate detection modes of operation M0 and M1, where the mode M0 represents a contactless IC card detection mode of operation in a particular standard, and the mode M1 represents an RF ID tag detection mode of operation in another particular standard.

In FIG. 8, the reader/writer 200 first sets the detection mode of operation M0 and its initial state S00, and performs polling at the low transmission power LL in a transmission time slot 001. In a reception time slot 002, received data from the contactless IC card 310, i.e. the unique ID, is not detected (CD-A ND) due to a time-out. Following the long delay DL, the reader/writer 200 sets the detection mode of operation M1 and its state S00, and performs polling at the low transmission power LL in a time slot 003. In a time slot 004, received data from the RF ID tag is not detected (TG-B ND). Following the long delay DL, the reader/writer 200 sets the detection mode of operation M0 and its state S00, and performs polling at the low transmission power LL in a time slot 005. In a time slot 006, received data, i.e. the unique ID, of the contactless IC card 310 is detected (CD-A DT). However, a data error occurs due to the low received power level. Following the short delay DS, the reader/writer 200 sets the state S1 in the same detection mode of operation M0, and performs polling at the medium-level transmission power (ML) in a time slot 007. In a time slot 008, it detects received data, i.e. the same unique ID, and produces a reception acknowledgement (ACK) because of the sufficiently large received power level. The reader/writer 200 transmits the command to read the contactless IC card 310 as occasion demands (CD-A RD), to perform the read from and/or write to the contactless IC card 310.

Following the short delay DS, the reader/writer 200 sets the detection mode of operation M1 and its state S01, and performs polling at the low transmission power LL in a time slot 009. In a time slot 010, Received data is not detected (ND). Following the short delay DS, the reader/writer 200 sets the detection mode of operation M0 and its state S1, and performs polling at the medium-level transmission power ML in a time slot 011. In a time slot 012, received data is not detected (ND). The operations in time slots 013 to 016 are similar to those of the time slots 009 to 012. In the time slot 016, the timer 274 set after the time slot 008 indicates a time-out. Following the long delay DL, the operations develop in time slots 017 to 020 in a manner similar to those in the time slots 001 to 004.

Following the long delay DL, the reader/writer 200 sets the detection mode of operation M1 and its state S00, and performs polling at the low transmission power LL in a time slot 021. In a time slot 022, received data, i.e. the unique ID, of the RF ID tag 350 is detected (TG-B DT). However, a data error occurs due to the low received power level. Following the short delay DS, the reader/writer 200 sets the same detection mode of operation M1 and its state S2, and performs polling at the high transmission power HL in a time slot 023. In a time slot 024, it detects received data, i.e. the same unique ID, and produces a reception acknowledgement (ACK) because of the sufficiently large received power level. The reader/writer 200 transmits the read command as occasion demands (TG-B RD), to perform the read from and/or write to the contactless IC card 310. Following the short delay DS, the reader/writer 200 sets the detection mode of operation M0 and its state S01, and performs polling at the low transmission power LL in a time slot 025. In a time slot 026, received data is not detected (ND). Following the short delay DS, the operations develop in time slots 027 to 028 in a manner similar to those in the time slots 023 to 024. The operations develop in time slots 029 to 036 in a manner similar to those in the time slots 025 to 028, but received data is not detected (ND). In the time slot 036, the timer 274 set after the time slot 028 indicates a time-out. In a time slot 037, the reader/writer 200 returns to its initial state, and sets the state S00 in the detection mode of operation M0 again and performs polling at the low transmission power LL, and waits for a response in a time slot 038.

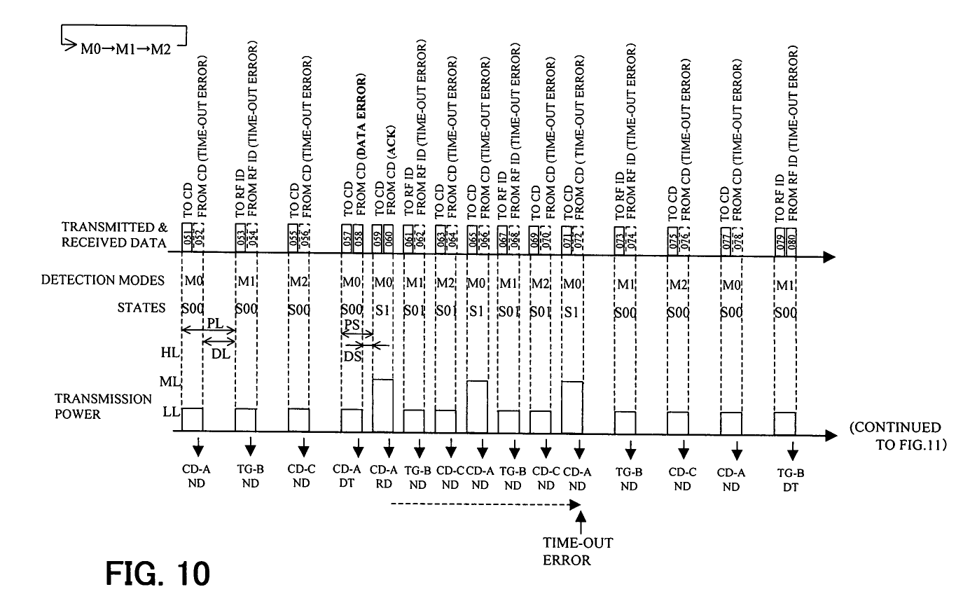

FIG. 9 illustrates another exemplary timing chart of the states and the transmission power developed by the reader/writer 200 in accordance with the flowchart of FIG. 7 in the two alternate modes of operation M0 and M1.

In FIG. 9, the operations develop in the time slots 001 to 0013 in a manner similar to those in FIG. 8. In the time slot 014, received data is detected (DT). Following the short delay DS, the reader/writer 200 sets the state S2 in the same detection mode of operation M1, and performs polling at the high transmission power HL in the time slot 015. In the time slot 016, it detects the received data unique ID, and produces a reception acknowledgement (ACK) because of the sufficiently large received power level. The reader/writer 200 transmits the read command as occasion demands (RD), to perform the read from and/or write to the contactless IC card 310. Following the short delay DS, the operations develop in time slots 017 to 018 in a manner similar to those in the time slots 011 to 012. Following the short delay DS, the operations develop in the time slots 019 to 030 in a manner similar to those in the time slots 027 to 038 of FIG. 8. In the time slot 018, the timer 274 set after the time slot 008 indicates a time-out. In the time slot 028, the timer 274 set after the time slot 020 indicates a time-out.

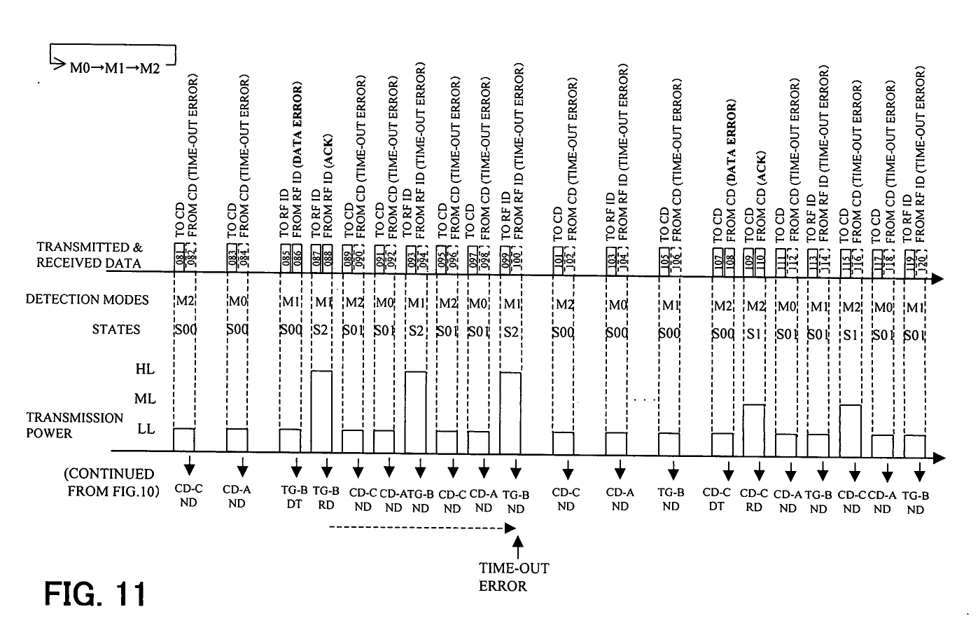

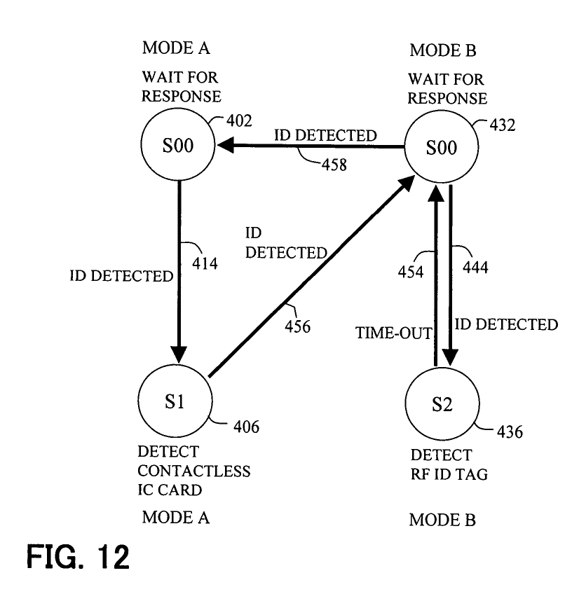

FIGS. 10 and 11 illustrate a further exemplary timing chart of the states and the transmission power developed by the reader/writer 200 in accordance with the flowchart of FIG. 7 in the three different cyclic modes of operation M0, M1 and M2, where the mode M2 represents a contactless IC card detection mode of operation in a further particular standard.

The timing chart of FIGS. 10 and 11 takes on a form in which time slots in the detection mode of operation M2 are inserted between the time slots in the detection modes of operation M1 and M0 in the timing chart of FIG. 8. In FIGS. 10 and 11, in time slots 051 to 058, 073 to 086 and 101 to 108 as in the time slots 001 to 006, 017 to 022 and 037 to 038 in FIG. 8, the reader/writer 200 sets the state S00 in the detection modes of operation M0, M1 and M2, and performs polling at the low transmission power LL following the long delay DL. Time slots 059 to 060, 065 to 066 and 071 to 072 correspond to the time slots 007 to 008, 011 to 012 and 015 to 016 in FIG. 8. Time slots 061 to 062 and 067 to 068 correspond to the time slots 009 to 010 and 013 to 014 in FIG. 8. Time slots 087 to 088, 093 to 094 and 099 to 100 correspond to the time slots 027 to 028, 031 to 032 and 035 to 036 in FIG. 8. Time slots 091 to 092 and 097 to 098 correspond to the time slots 029 to 030 and 033 to 034 in FIG. 8. In time slots 063 to 064, 069 to 070, 089 to 090, and 095 to 096 following the short delay DS, the reader/writer 200 sets the detection mode of operation M2 and its state S01, and performs polling at the low transmission power LL.

In FIG. 11, following the long time delay DL, the reader/writer 200 sets the detection mode of operation M2 and its state S00, and performs polling at the low transmission power LL in a time slot 107. In a time slot 108, received data is detected (DT). Following the short delay DS, the reader/writer 200 sets the state S1 in the same detection mode of operation M2, and performs polling at the medium-level transmission power ML in a time slot 109. In a time slot 110, it detects received data, and produces a reception acknowledgement (ACK) because of the sufficiently large received power level. The reader/writer 200 transmits the read command as occasion demands (RD), to perform the read from and/or write to the contactless IC card 310. Following the short delay DS, the operations develop in time slots 111 to 120 similarly for detecting the unique ID.

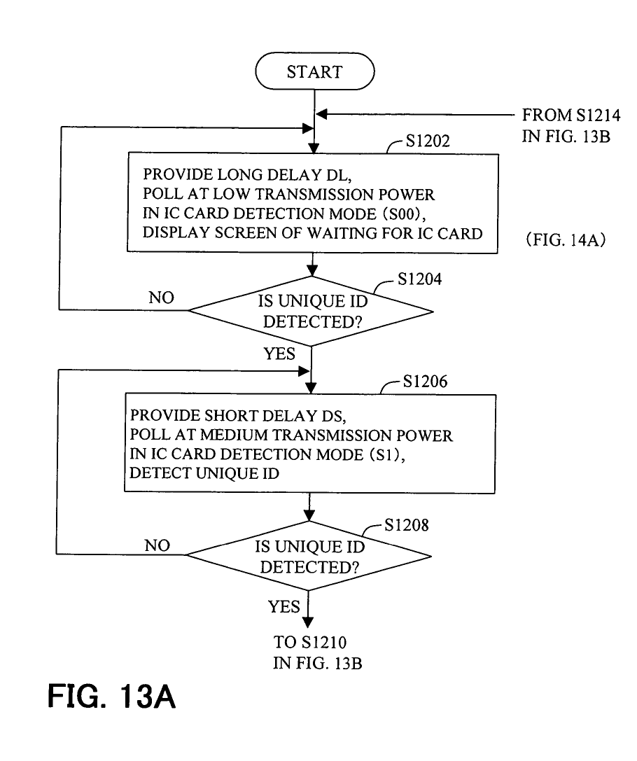

FIG. 12 shows another state transition diagram for detecting the contactless IC card 310 in the contactless IC card detection mode of operation first and then entering the RF ID tag detection mode of operation to detect the RF ID tag 350, in accordance with another embodiment of the invention.

In FIG. 12, the reader/writer 200 operates in the contactless IC card detection mode of operation MODE A and is in the state S00 designated as 402 in its initial state. The reader/writer 200 goes into the state S1 designated as 406 as indicated by the arrow 414 upon detecting reception of a response from the contactless IC card 310 containing the unique ID while it is in the state S00 designated as 402. The reader/writer 200 goes into the RF ID tag detection mode of operation MODE B and its state S00 designated as 432 as indicated by the arrow 456 upon detecting reception of a response from the contactless IC card 310 containing the unique ID while it is in the state S1.

The reader/writer 200 operates in the RF ID tag detection mode of operation MODE B while it is in the state S00 designated as 432, and goes into the state S2 designated as 436 as indicated by the arrow 444 upon detecting reception of a response from the RF ID tag 350 containing the unique ID. When the reader/writer 200 receives no response for a predetermined period of time while it is in the state S2, it returns to the state S00 designated as 432 as indicated by the arrow 454 due to a time-out. When the reader/writer 200 receives no response for a predetermined period of time while it is in the state S00 designated as 432, it returns to the state S00 designated as 402 as indicated by an arrow 458 due to a time-out, and operates in the contactless IC card detection mode of operation MODE A.

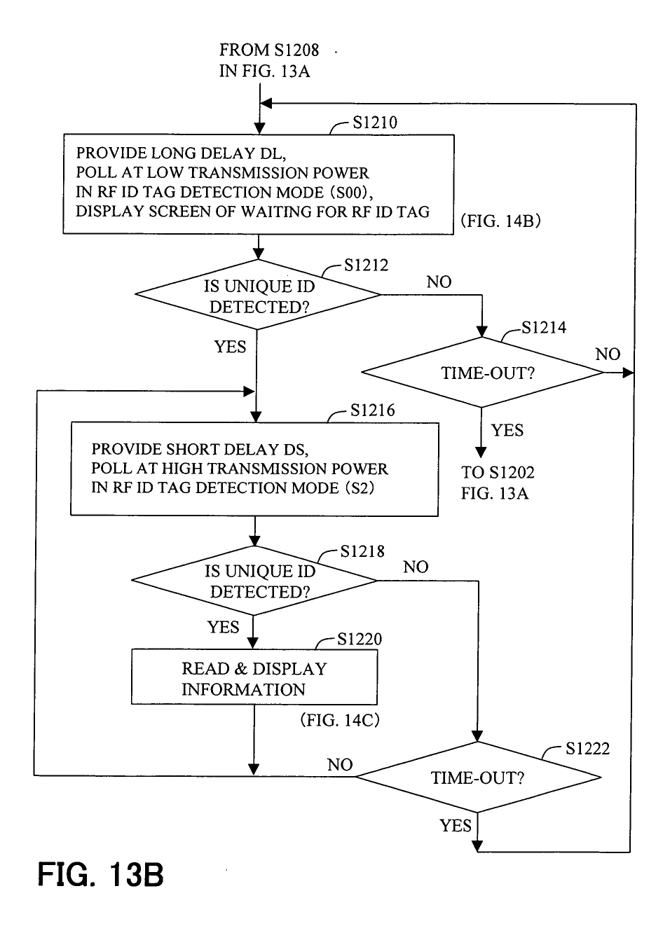

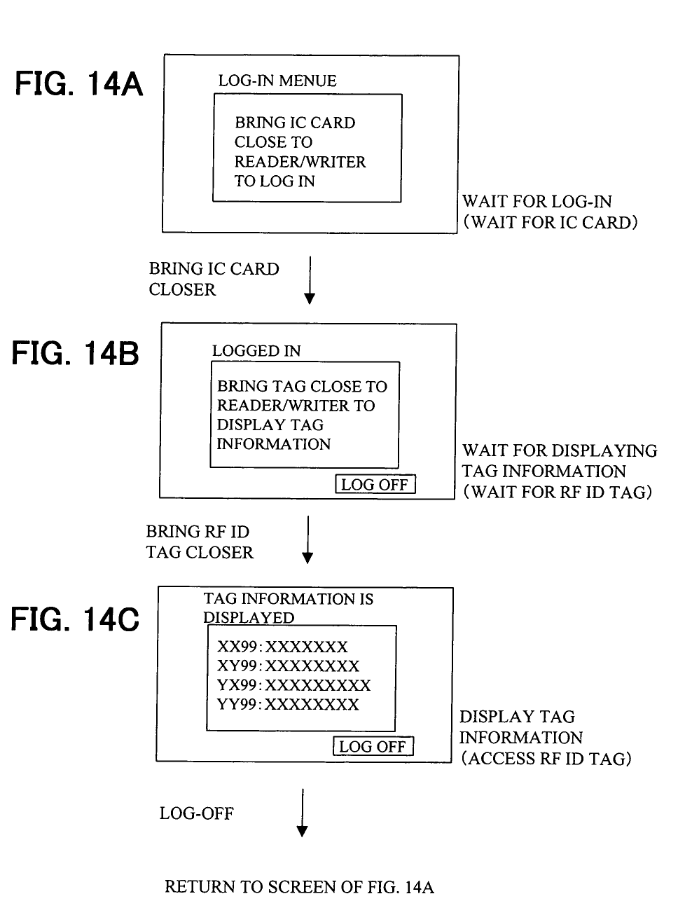

FIGS. 13A and 13B show a flowchart for detecting the contactless IC card 310 in the contactless IC card detection mode of operation and then entering the RF ID tag detection mode of operation to detect the RF ID tag 350, in accordance with the state transition diagram of FIG. 12, performed by the processor 170 in accordance with a control program stored in the memory 172 and by the state control unit 270 of the reader/writer 200 in accordance with a control program stored in the memory 272, in accordance with the embodiment of the invention. FIGS. 14A, 14B and 14C illustrate screens displayed on the display device 174 at Steps 1202, 1210 and 1220 in the flowchart of FIGS. 13A and 13B.

In FIG. 13A, at Step 1202, the state control unit 270 controls the interval control unit 284 to provide the long time delay DL (e.g., 480 ms) before the next poling, controls the data encoding unit 220 and the modulation unit 232 to operate in the respective predetermined encoding and modulation schemes in accordance with the contactless IC card detection mode of operation M0, and controls the transmission power control unit 282 to set the low or lowest transmission power LL (state S00) to the amplifier unit 234. The data control unit 210 transmits and receives data in the detection mode of operation M0 set by the state control unit 270, to thereby allow the reader/writer 200 to poll the contactless IC card 310 and detect its response. During this period, the processor 170 causes the display device 174 to display the screen of FIG. 14A for instructing the user to bring the contactless IC card 310 close to it, i.e. a screen of waiting for a contactless IC card. At Step 1204, the reader/writer 200 determines whether the unique ID of the contactless IC card 310 is detected. If the unique ID is not detected, the procedure returns to Step 1202. Steps 1202 and 1204 are repeated until the unique ID is detected.

If the unique ID is detected at Step 1204, the state control unit 270 at Step 1206 controls the interval control unit 284 to provide the short delay DS and then controls the transmission power control unit 282 to raise the transmission power of the amplifier unit 234 to the medium level ML, a higher level, to thereby allow the data control unit 210 to transmit data. This allows polling and detection of the unique ID in the contactless IC card detection mode of operation M0, and reading and/or writing corresponding data from and/or to the contactless IC card 310 as occasion demands (state S1). At Step 1208, the reader/writer 200 determines whether the unique ID of the card 310 is detected. If the unique ID is not detected, the procedure returns to Step 1202. Steps 1206 and 1208 are repeated until the unique ID is detected. The procedure may return to Step 1202 if the unique ID is not detected for a predetermined period of time.

If the unique ID is detected at Step 1208, the state control unit 270, at Step 1210 in FIG. 13B, controls the interval control unit 284 to provide the long time delay DL (e.g., 480 ms), sets the RF ID tag detection mode of operation M1, and controls the transmission power control unit 282 to set the low or lowest transmission power LL, to thereby allow the reader/writer 200 to perform polling (state S00). During this period, the processor 170 causes the display device 174 to display the screen of FIG. 14B for instructing the user to bring the RF ID tag 350 close to it, i.e. a screen of waiting for an RF ID tag. At Step 1212, the state control unit 270 determines whether the unique ID of the RF ID tag 350 is detected. If the unique ID is not detected, the state control unit 270 at Step 1214 determines whether failure to detect the RF ID tag has lasted for a predetermined period of time, i.e., whether a time-out has occurred. If it is determined that a time-out has occurred, the procedure returns to Step 1202 in FIG. 13A. If it is determined that a time-out has occurred, the procedure returns to Step 1210.

If the unique ID is detected at Step 1212, the state control unit 270 at Step 1216 controls the interval control unit 284 to provide the short time delay DS and then controls the transmission power control unit 282 in the same detection mode of operation to raise the transmission power to the higher or highest level HL, to perform polling again and detection of the unique ID and the read and/or write corresponding data as occasion demands (state S2). At Step 1218, the reader/writer 200 determines whether the unique ID of the RF ID tag 350 is detected. If the unique ID is not detected, the state control unit 270 at Step 1222 determines whether failure to detect the RF ID tag has lasted for the predetermined period of time, i.e., whether a time-out has occurred. If it is determined that a time-out has occurred, the procedure returns to Step 1210. If it is determined that a time-out has not occurred, the procedure returns to Step 1216.

If it is determined at Step 1218 that the unique ID is detected, the processor 170 causes the display device 174 to display the screen of FIG. 14C for showing the detected unique ID and the read information. The process then returns to Step 1216. Thus, following authentication of the user by the contactless IC card 310, information is read from the single or plurality of RF ID tags 350 attached to commodities or the like.

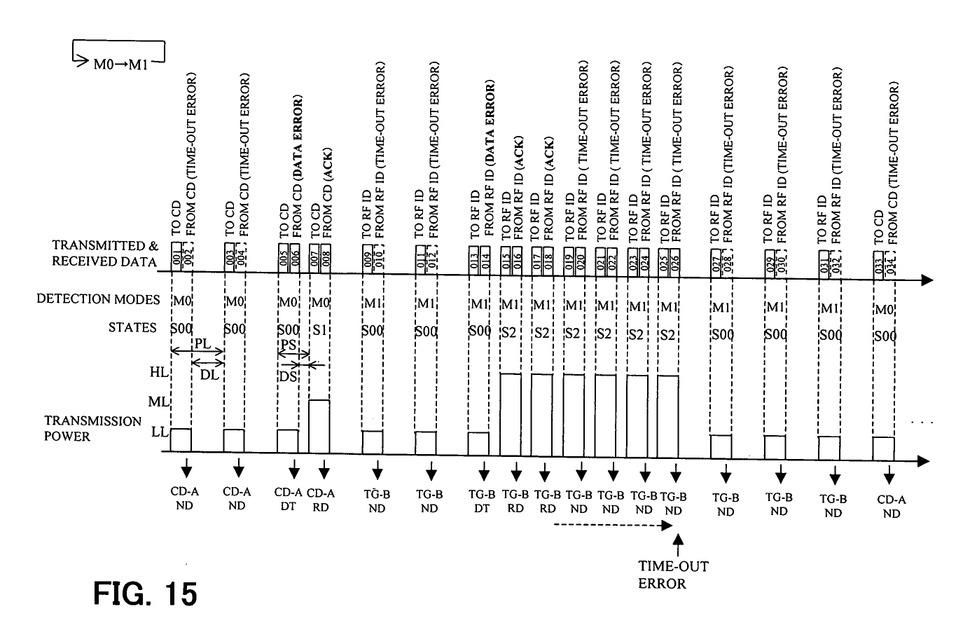

FIG. 15 illustrates an exemplary timing chart of the states and the transmission power developed by the reader/writer 200 in accordance with the flowchart of FIGS. 13A and 13B in the two modes of operation M0 and M1. In the time slots 001 to 006, Step 1202 in FIG. 13A is reiteratively executed. In the time slots 007 to 008, Step 1206 in FIG. 13A is executed. In the time slots 009 to 014, Step 1210 in FIG. 13B is reiteratively executed. In the time slots 015 to 026, Steps 1216 and 1220 in FIG. 13B are executed. Following the time-out, Step 1210 in FIG. 13B is executed again in the time slots 027 to 032. Following the time-out, the reader/writer 200 returns to its initial state, to execute Step 1202 again in the time slots 033 to 034.

The above-described embodiments are only typical examples, and their modifications and variations are apparent to those skilled in the art. It should be noted that those skilled in the art can make various modifications to the above-described embodiments without departing from the principle of the invention and the accompanying claims.

1. An information processing apparatus for communicating with a separate passive device, to receive specific information from the separate device, said information processing apparatus comprising an antenna, a transmitter and a receiver both coupled to said antenna, and a control unit for controlling said transmitter, wherein
said control unit causes said transmitter to transmit a signal at a low transmission power and waits for reception by said receiver of a response signal from the separate device, and
when the specific information is detected in the response signal, said control unit causes said transmitter to transmit a signal at a high transmission power by raising the transmission power of said transmitter, to thereby enable information to be read from or written to the separate device.

2. The information processing apparatus according to claim 1, wherein the separate device is a contactless IC card or an RF ID tag.

3. The information processing apparatus according to claim 1, wherein the control unit sets a transmission interval of the signal transmitted at the low transmission power to a first predetermined value until the specific information is detected in the response signal, and wherein said control unit sets a transmission interval of the signal transmitted at the high transmission power to a second predetermined value which is shorter than the first predetermined value.

4. The information processing apparatus according to claim 1, wherein the separate device is a contactless IC card or an RF ID tag, and wherein said control unit causes said transmitter to transmit a signal for a contactless IC card and a signal for an RF ID tag alternately at the low transmission power.

5. The information processing apparatus according to claim 1, wherein
said control unit causes said transmitter to transmit a signal for a contactless IC card at the low transmission power, and
when first identification information is detected in the response signal from the separate device received by said receiver, said control unit causes said transmitter to transmit a signal at the high transmission power to detect first particular information, and wherein
said control unit then causes said transmitter to transmit a signal for an RF ID tag at the low transmission power, and
when second identification information is detected in the response signal from the separate device received by said receiver, the control unit causes said transmitter to transmit a signal at the high transmission power to detect second particular information.

6. The information processing apparatus according to claim 1, further comprising a display unit for displaying a screen of instructing a user to place the separate device closer to said receiver of said information processing apparatus, and for displaying information received from the separate device.

7. A program product stored on a storage medium for use in an information processing apparatus which comprises a transmitter and a receiver and which is capable of communicating with a separate passive device, and for receiving specific information from the separate device, said program product being operable to effect the steps of:
causing the transmitter to transmit a signal at a low transmission power and waiting for reception by the receiver of a response signal from the separate device; and
causing the transmitter to transmit a signal at a high transmission power by increasing the transmission power of the transmitter when specific information is detected in the response signal, to thereby enable information to be read from or written to the separate device.

8. In an information processing apparatus which comprises a transmitter and a receiver and which is capable of communicating with a separate passive device, a method for receiving specific information from the separate device, said method comprising:
causing the transmitter to transmit a signal at a low transmission power and waiting for reception by the receiver of a response signal from the separate device; and
causing the transmitter to transmit a signal at a high transmission power by increasing the transmission power of the transmitter when specific information is detected in the response signal, to thereby enable information to be read from or written to the separate device.
